(19) United States
(12) Patent Application Publication
(10) Pub. No.: US 2018/0340882 A1
(43) Pub. Date: Nov. 29, 2018

(54) FILTER FOR CAPTURING AND ANALYZING DEBRIS IN A MICROFLUIDIC SYSTEM

(71) Applicant: Owl biomedical, Inc., Goleta, CA (US)

(72) Inventors: John S. FOSTER, Santa Barbara, CA (US); Mehran Hoonejani, Goleta, CA (US); Kevin SHIELDS, Santa Barbara, CA (US)

(73) Assignee: Owl biomedical, Inc., Goleta, CA (US)

(21) Appl. No.: 15/605,933

(22) Filed: May 25, 2017

(51) Int. Cl. G01N 15/14; B01L 3/00; B01D 29/44

(52) U.S. Cl. CPC G01N 15/1484; B01L 3/502715; B01L 3/502738; B01L 3/502753; G01N 15/1404; B01D 29/44; G01N 2015/1006; B01L 2200/0631; B01L 2300/0887; B01L 2200/0652; B01L 2300/0654; B01L 2200/141; B01L 2200/12; B01L 2300/0681

(57) ABSTRACT

Described here is a microfabricated particle filtering structure having at least one microchannel formed in a surface of a silicon substrate. The filter structure uses a plurality of barriers formed in at least one microchannel, wherein a distance between the closest barriers is small enough to capture the particulate debris but allow the sample fluid to flow, and a transparent layer that covers the silicon substrate, and the plurality of barriers. The debris captured by the barriers may be analyzable through the transparent layer, helping in determining the source of the debris.

### CROSS REFERENCE TO RELATED APPLICATIONS

Not applicable.

### STATEMENT REGARDING FEDERALLY SPONSORED RESEARCH

Not applicable.

### STATEMENT REGARDING MICROFICHE APPENDIX

Not applicable.

### BACKGROUND

This invention relates to a system and method for manipulating small particles in a microfabricated fluid channel.

Microelectromechanical systems (MEMS) are very small, often moveable structures made on a substrate using surface or bulk lithographic processing techniques, such as those used to manufacture semiconductor devices. MEMS devices may be moveable actuators, sensors, valves, pistons, or switches, for example, with characteristic dimensions of a few microns to hundreds of microns. A moveable MEMS switch, for example, may be used to connect one or more input terminals to one or more output terminals, all microfabricated on a substrate. The actuation means for the moveable switch may be thermal, piezoelectric, electrostatic, or magnetic, for example. MEMS devices may be fabricated on a semiconductor substrate which may manipulate particles passing by the MEMS device in a fluid stream.

In another example, a MEMS device may be a movable valve, used as a sorting mechanism for sorting various particles from a fluid stream, such as cells in blood or saline. The particles may be transported to the sorting device within the fluid stream enclosed in a microchannel, which flows under pressure. Upon reaching the MEMS sorting device, the sorting device directs the particles of interest such as a blood stem cell, to a separate receptacle, and directs the remainder of the fluid stream to a waste receptacle.

MEMS-based cell sorter systems may have substantial advantages over existing fluorescence-activated cell sorting systems (FACS) known as flow cytometers. Flow cytometers are generally large and expensive systems which sort cells based on a fluorescence signal from a tag affixed to the cell of interest. The cells are diluted and suspended in a sheath fluid, and then separated into individual droplets via rapid decompression through a nozzle. After ejection from a nozzle, the droplets are separated into different bins electrostatically, based on the fluorescence signal from the tag. Among the issues with these systems are cell damage or loss of functionality due to the decompression, difficult and costly sterilization procedures between sample, inability to re-sort sub-populations along different parameters, and substantial training necessary to own, operate and maintain these large, expensive pieces of equipment. For at least these reasons, use of flow cytometers has been restricted to large hospitals and laboratories and the technology has not been accessible to smaller entities.

A number of patents have been granted which are directed to the smaller MEMS-based particle sorting devices. For example, U.S. Pat. No. 6,838,056 (the '056 patent) is directed to a MEMS-based cell sorting device, U.S. Pat. No. 7,264,972 b1 (the '972 patent) is directed to a micromechanical actuator for a MEMS-based cell sorting device. U.S. Pat. No. 7,220,594 (the '594 patent) is directed to optical structures fabricated for a MEMS cell sorting apparatus, and U.S. Pat. No. 7,229,838 (the '838 patent) is directed to an actuation mechanism for operating a MEMS-based particle sorting system. Additionally, U.S. patent application Ser. Nos. 13/374,899 (the '899 application) and Ser. No. 13/374,898 (the '898 application) provide further details of other MEMS designs. Each of these patents ('056, '972, '594 and '838) and patent applications ('898 and '899) is hereby incorporated by reference.

One of the challenges to this cell sorting concept is the inevitable presence of debris in the sample stream. Because of the small dimensions of these MEMS devices, tolerances are correspondingly small, and a small bit of unexpected contamination may clog or jam the movable mechanisms. Many MEMS devices are sensitive to low levels of contamination. For example, U.S. patent application Ser. No. 15/159841 (Attorney Docket No. Owl-CatsPaw) deals with precisely this issue.

In part because of its sensitivity to contamination, MEMS-based particle sorting devices have been slow to appear in the marketplace.

### SUMMARY

Disclosed here is a particle filtering structure which is microfabricated in nature, and can filter very small particles of debris from a sample stream. Furthermore, a transparent layer disposed on top of the microfabricated filter channels allows a qualitative and quantitative analysis of the filtered debris, which may assist in identifying its source.

The microfabricated particle filtering device may use a series of photolithographically fabricated barriers of various shapes and sizes to trap contaminant particles flowing in a sample stream through the small channels. The barriers and channels may include ramps, combs, labyrinths or any other structure that impedes or detains the flow of particulate debris in the channel.

The channel, as well as the barriers, may be formed in a semiconductor substrate using photolithographic manufacturing techniques such as those used to make semiconductor integrated circuits or MEMS devices. Accordingly, relatively complex shapes may be made easily and with high precision and in large volume on semiconductor substrates.

A plurality of embodiments is described herein, with the microfabricated filter barriers having various shapes, sizes and relative positioning, depending on the application and the nature of the contamination expected.

An important feature in this device is the use of a transparent layer on top of the substrate and enclosing the small channels and microfabricated barriers. With this transparent layer, analysis methodologies may be applied to the trapped debris. This analysis may include microscopic observation, spectrometry, and scattering, for example. The information generated by the analysis methodology may allow the identification of the source of the debris, and the elimination of this source.

Accordingly, a microfabricated filter is disclosed, for capturing and analyzing debris in a microfluidic system. The filter may include an inlet port wherein a sample fluid having particulates suspended therein is introduced to the filter and an output port whereby the sample fluid exits the filter, wherein the inlet port and the output port are formed in a silicon substrate and the sample fluid flows in a plane substantially parallel to the surface from the inlet to the outlet port. The filter may further include at least one microchannel in a surface of the silicon substrate, and through which the sample fluid flows, a plurality of barriers formed in at least one microfabricated channel, wherein a distance between the closest barriers is small enough to capture the particulate debris but allow the sample fluid to flow, and a transparent layer that covers the silicon substrate, and the plurality of barriers.

The microfabricated filter may be used upstream from a microfabricated cell sorting device, in order to remove particles which might otherwise interfere with the functioning of the device. This cell sorting structure may also be fabricated on a substrate, wherein the microfabricated particle sorting device separates a target particle from non-target material flowing in a fluid stream. The particle sorting device may include a detection region which generates a signal distinguishing the target particle from non-target material, a sample inlet channel, a sort channel and a waste channel also fabricated on the same substrate, wherein a target particle may be urged into the sort channel rather than the waste channel by either a movable diverting surface or by a transient pulse of fluidic pressure. The movement or the pulse of pressure may be generated by an actuator fabricated on the same substrate as the sample inlet channel, and may use, for example, electromagnetic forces to move the movable portions.

### BRIEF DESCRIPTION OF THE DRAWINGS

Various exemplary details are described with reference to the following figures, wherein:

FIG. 1a is a cross sectional illustration of a microfabricated filter for a cell sorting system; FIG. 1b is a plan view of the microfabricated filter;

FIG. 2 is a plan view of another embodiment of a microfabricated filter, showing a plurality of parallel paths and microfabricated filter barriers;

FIG. 3 is a plan view of another embodiment of s microfrabricated filter with varying filter separations; and

FIG. 4a is a plan view of a microfabricated cell sorter which may make use of the microfrabricated filter with varying filter separations in the unactuated position; FIG. 4b is a plan view of a microfabricated cell sorter which may make use of the microfrabricated filter with varying filter separations in the actuated position.

It should be understood that the drawings are not necessarily to scale, and that like numbers may refer to like features.

### DETAILED DESCRIPTION

The microfabricated filter may be fabricated on the surface of a substrate, using photolithographic techniques to form sharp, well defined barriers which may trap the particles of debris or contamination before they reach the particle manipulation stage, which may be, for example, a microfabricated cell sorter. While the microfabricated filter is described with respect to the microfabricated cell sorter embodiment, it should be understood that the filter may be used in other applications, such as cytometers or other analysis tools.

Microfabricated cell sorting systems that may use this microfabricated filter are described in detail in U.S. patent application Ser. No. 15/436,771, and U.S. Pat. No. 9,372,144, each of which is incorporated by referend. These microfabricated particle manipulators may separate a target particle form non-target material in a sample stream. The microfabricated filter may be used upstream of these cell sorters to remove debris which may otherwise clog or jam the delicate structures of the sorter. First, the microfabricated filter structure will be described in general. Following that description is an exemplary embodiment of a cell sorting system using the microfabricated filter.

A sample stream containing at least one target particle as well as non-target material and possible contaminants may be introduced to the device from a sample reservoir to a sample inlet channel and through the microfabricated filter. After the filter, the sample inlet channel may pass through a query zone, wherein a detector may detect the presence of a target particle. Upon detection of a target particle in the query zone, a controller may direct a force generating structure to generate a force to move the movable member of the actuator. Movement of the actuator may generate the transient pressure pulse, directing the target particle from the waste stream into the sort stream and then on to the sort reservoir. In some embodiments, the transient pressure pulse may be positive, pushing the target particle into the sort channel. Alternatively, the actuation means may move a diverting surface which directs the target particle into the sort channel.

The actuation means may be electromagnetic, wherein an electromagnet, separate and external to the substrate supporting the fluid channels and actuator produces magnetic flux in the vicinity of the actuator. A magnetically permeable feature in the substrate and in the actuator may interact with the electromagnet, causing the actuator to move. The movement of the actuator may create the transient pressure pulse, or movement of a diverting surface, the target particle from a nominal path into a waste reservoir, into another sort channel path and sort reservoir.

The following discussion presents a plurality of exemplary embodiments of the novel particle filtering system. The following reference numbers are used in the accompanying figures:
1, 2, 3 microfabricated filter
5 debris particle
10 substrate
12 the sample input channel
14 the sample output channel
30 transparent layer
22, 24 filter barriers
34, 36, 38 angular filter barriers
40 analysis unit
100 microfabricated cell sorter
110 movable member
112 diverting surface
120 sample channel
122 sort channel
140 waste channel
400 force generating means

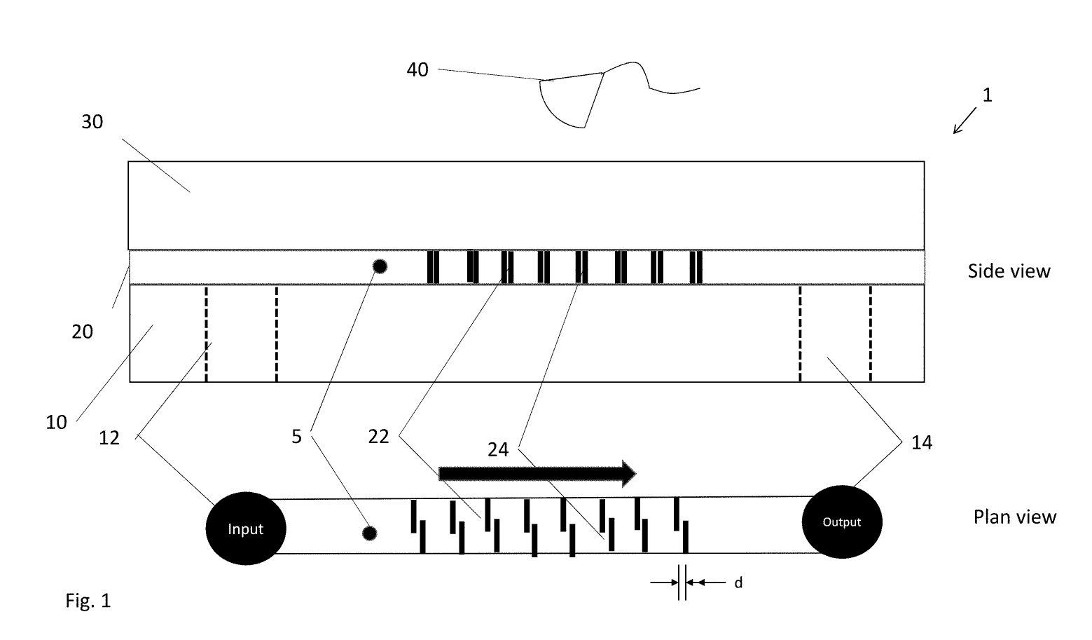

FIG. 1a is a cross sectional illustration of a microfabricated filter. The filter may be used in, for example, a cell sorting system as described below. In FIG. 1a, a sample stream may include at least one debris particle 5, suspended therein. The sample stream may be admitted to the filter structure 1 through an inlet channel 12, from which it may flow laterally across the face of the substrate 10 as shown by the arrow in FIG. 1b. The flow may traverse a series of filter barriers 22, 24 which are arranged so as not to seal the channel to the flow of the sample stream, but to trap particles of a particular size which may be suspended in the sample stream. In FIG. 1a and 1b, these filter barriers are disposed in a staggered arrangement across the width of the channel. However, no barriers extend entirely across the channel so as to seal it against the flow. Instead, the sample stream may flow between the staggered barriers 22 and 24 which may be separated by a distance d. Accordingly, particulate debris with a dimension greater than d may be trapped in the filter 1.

As shown in FIG. 1a, the microfabricated channel with filter barriers 22, 24 may be sealed on top by another layer or substrate 30. This layer or substrate 30 may be optically transparent, allowing radiation to pass through and impinge upon the trapped particle 5. The transparent layer 30 may comprise at least one of quartz, sapphire, zirconium, ceramic, and glass. The transparent layer 30 may allow analysis and characterization of the particulate debris found in the sample stream. Such information may be important in identifying and correcting the source of the contamination. FIG. 1a shows evaluation of trapped particle 5 by an analysis unit 40, such as a microscope or spectrometer. The analysis technique may include investigation of specular, diffractive, refractive behaviors of the particle 5, for example. Accordingly, the filter system may include an optical microscope which is disposed adjacent to the filter and is configured to image the particulates intercepted by the plurality of barriers, through the transparent layer 30. Alternatively, the analysis tool may be a spectrometer which is disposed adjacent to the filter and is configured to analyze the particulates intercepted by the plurality of barriers, through the transparent layer. In other embodiments, x-ray diffraction, crystallography, or other methods may be used to analyze the trapped debris through the transparently layer 30.

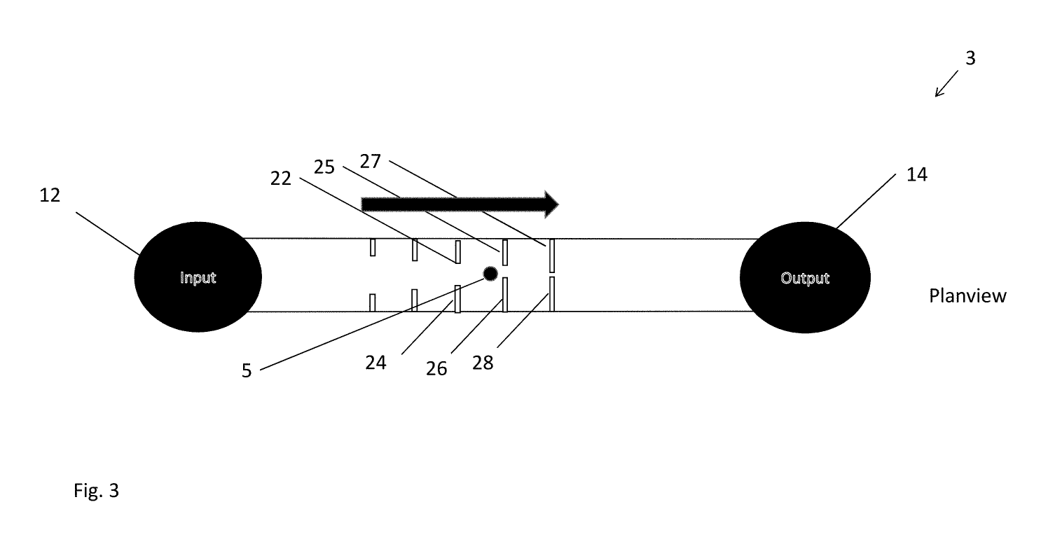

FIG. 1b is a plan view of the microfabricated filter. FIG. 1b shows effectively the staggered arrangement of the filter barriers 22 and 24. In one embodiment, each filter barrier 22 extends less than the full diameter, but over ½ of the diameter of the channel. Accordingly, by staggering pairs of like filter barriers 22, 24 one behind the other, the channel remains open to the passing of the sample stream but will trap particles of debris with a dimension larger than the distance between the barriers. In other embodiments, such as is shown in FIG. 3, the filter barriers 22, 24 extend less than ½ the distance across the channel, such that the fluid may flow between the barriers but particulate debris may not. Accordingly, in some embodiments, at least one of the plurality of barriers has a rectangular shape, and there is a varying distance between opposing barriers.

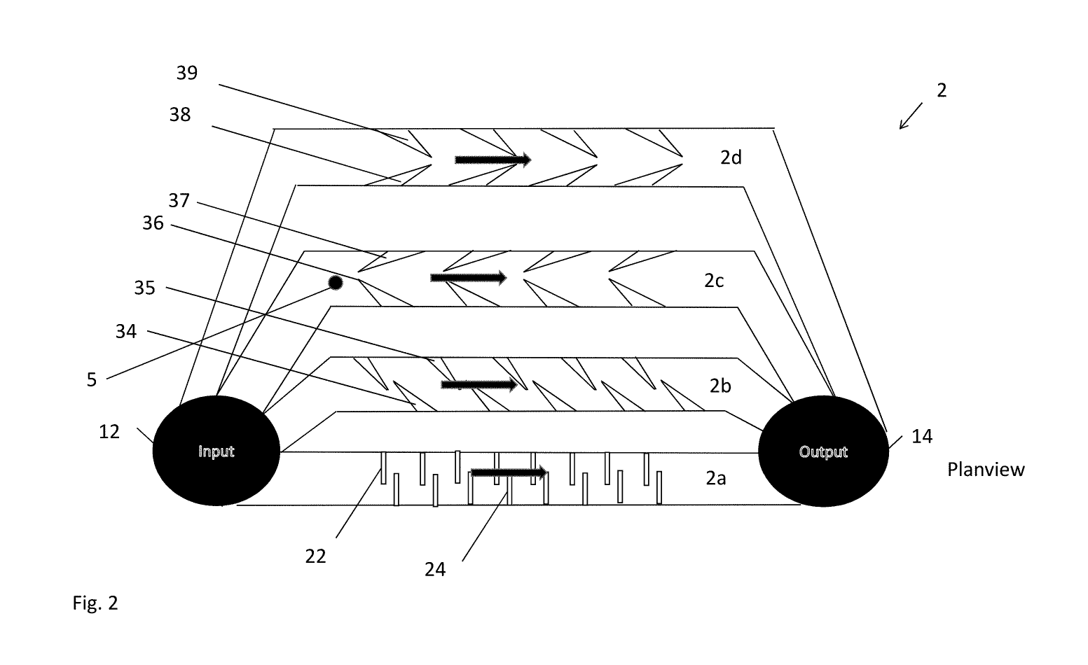

FIG. 2 is a plan view of another embodiment of a microfabricated filter, showing a plurality of parallel paths 2a, 2b, 2c and 2d, each with filter barriers 24, 34, 36 and 38 respectively. It should be understood that although the paths 2a, 2b, 2c and 2d each have different shapes of filter barriers 24, 34, 36 and 38, this is not necessarily the case. In some embodiments, the filter barriers may be the same in the parallel paths 2a, 2b, 2c and 2d. In other embodiments, the filter barriers may be different. The paths are shown as being in parallel, but this is also exemplary only, and some filter barrier shapes 24, 34, 36 and 38 may be placed serially before or after other filter barrier shapes. It should be appreciated that since the filter barriers are fabricated lithographically, the shapes may be made arbitrarily complex.

The sample stream may again be input to the filter 2 through an input channel 12, from which it may flow laterally across the face of the substrate 10 as shown by the arrows in FIG. 2a-2d. The flow may traverse a series of filter barriers 22, 34, 36 and 38 which are arranged so as not to seal the channel to the flow of the sample stream, but to trap particles of a particular size which may be suspended in the sample stream. In FIG. 2a-2d, these filter barriers are disposed in a staggered arrangement across the width of the channel. However, no barriers extend entirely across the channel so as to seal it against the flow. Instead, the sample stream may flow between the staggered barriers 22 and 24 which may be separated by a distance d. Accordingly, particulate debris with a dimension greater than d may be trapped in the filter barriers 34

In channel 2a, the filter barriers may be simple rectangles, similar to filter barriers 22, 24 in FIG. 1a and 1b. In other paths 2c-2d, the barriers may have a tapered shape, narrowing from base to tip. In channel 2b, the filter barriers 34 may lean into the flow, whereas filter barriers 35 lean away from the flow. In channel 2c, both filter barriers 36 and 37 may lean into the flow. In channel 2d, both filter barriers 38 and 39 may lean away from the flow. The different shapes and orientations may have different behaviors in terms of effectiveness in trapping particles. Each type of filter shape creates a specific flow circulation around it which traps particles based on their characteristics such as the relative rigidity or stiffness of the particle, or how round or rod-shaped a particle is.

Accordingly, the microfabricated filter may have plurality of barriers. At least one of the plurality of barriers has a tapered shape, narrowing from base to tip. In other embodiments, at least one of the plurality of barriers has a tapered shape, and is inclined into the sample fluid, such that the tapered shape points upstream into the flow. In other embodiments, at least one of the plurality of barriers has a tapered shape, and is inclined away from the sample fluid, such that the tapered shape points downstream in the flow. In other embodiments, at least one of the plurality of barriers has a tapered shape, wherein the tapered shape has a sharp tip. Other shapes of barriers may be used, such as sawtooth, pyramidal, trapezoidal and curved. But in each case, the barrier may be shaped and placed in the channel to capture contaminants and debris flowing past, and hold these particles for analysis and observation through the transparent layer 30. The silicon substrate may have a plurality of sample fluid channels formed therein, wherein each channel has a plurality of barriers formed therein, and the barriers in each channel are configured to intercept a different type of particulate debris.

As was shown in FIG. 1a, the microfabricated channel with filter 2 with parallel channels 2a, 2b, 2c and 2d may be sealed on top by another layer or substrate 30. This layer or substrate 30 may be optically transparent, allowing radiation to pass through and impinge upon the trapped particle 5. The transparent layer 30 may allow analysis and characterization of the particulate debris found in the sample stream. Such information may be important in identifying and correcting the source of the contamination. The analysis unit 40, may be, for example, a microscope or spectrometer. The analysis technique may include investigation of specular, diffractive, refractive behaviors of the particle 5, for example.

Although FIG. 2 shows four fluid channels flowing generally in parallel, it should be understood that this is exemplary only, and that the microfabricated filter 2 may have any number of channels, from a single channel, to a large number of generally parallel channels.

FIG. 3 is a plan view of another embodiment of a microfabricated filter 3 with varying filter separations. FIG. 3 demonstrates that the spacing between the filter barrier elements may vary along the direction of flow of the sample stream. The first set of barriers 22 and 24 have a rather wide spacing, allowing most if not all particles to pass. The next set of barriers 25 and 26 are more closely spaced, intercepting particles with a dimension that is too large for passage. The barriers become more closely spaced 26, 27 along the direction of flow until the final set 27 and 28 are encountered, which blocks most of the flow and most of the particles.

As was shown in FIG. 1a, the microfabricated channel with filter 3 with varying filter spacing 22-28 may be sealed on top by another layer or substrate 30. This layer or substrate 30 may be optically transparent, allowing radiation to pass through and impinge upon the trapped particle 5. The transparent layer 30 may allow analysis and characterization of the particulate debris found in the sample stream. Such information may be important in identifying and correcting the source of the contamination. The analysis unit 40, may be, for example, a microscope or spectrometer 40. The analysis technique may include investigation of specular, diffractive, refractive behaviors of the particle 5, for example. Using this analysis with the microfabricated filter 3 may provide information as to the size distribution of the particulate debris. More particularly, by observing the quantity of debris trapped at each filter barrier 22, 24, 25, 26, 27, and 28, the size distribution of the particulate matter may be characterized.

Accordingly, in some embodiments, the separation between the barriers may become narrower as the flow proceeds downstream in a microfluidic channel.

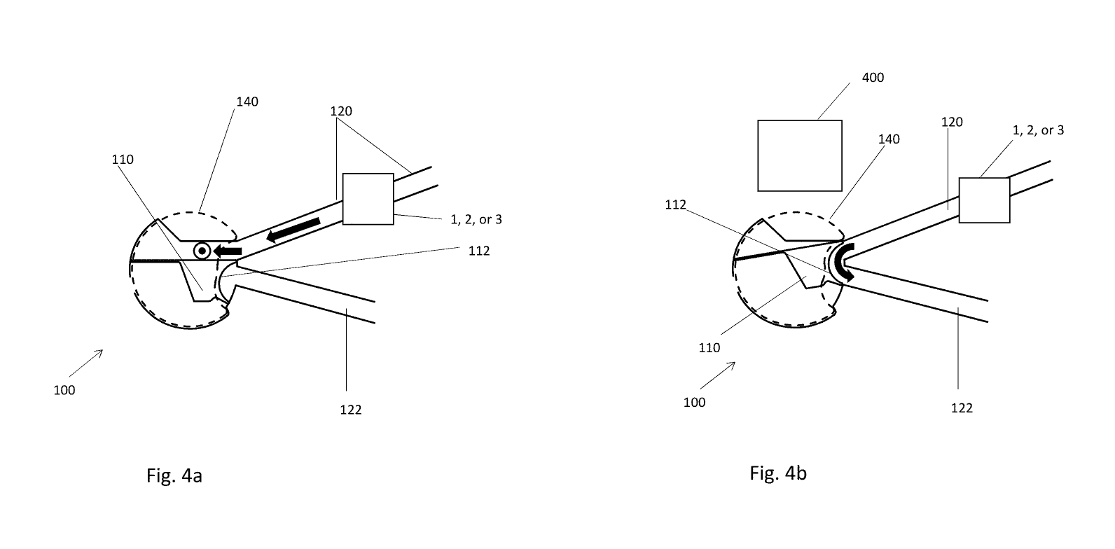

FIG. 4a is a plan view illustration of a microfabricated fluidic device 100 which may be used with the microfabricated filters 1, 2, or 3 described above. The microfabricated device 100 may be a cell sorter, and the cell sorter 100 is shown in the quiescent (un-actuated) position in FIG. 4a. The device 100 may include a microfabricated fluidic valve or movable member 110 and a number of microfabricated fluidic channels 120, 122 and 140. The fluidic microfabricated movable member 110 and microfabricated fluidic channels 120, 122 and 140 may be formed in a suitable substrate, such as a silicon substrate, using MEMS lithographic fabrication techniques as described in greater detail below. The fabrication substrate may have a fabrication plane in which the device is formed and in which the movable member 110 moves.

A microfabricated filter 1, 2, or 3 may be disposed upstream of a microfabricated fluidic device 100 as shown in FIGS. 4a and 4b, in order to trap or detain debris that would otherwise flow to the device 100. A sample inlet channel 120 may introduce a sample stream to the microfabricated filter 1, 2, or 3 and then continue to the fluidic movable member 110 by a sample inlet channel 120. The sample stream may contain a mixture of particles, including at least one desired, target particle and a number of other undesired, nontarget particles, and potentially some contamination or debris particles. The particles may be suspended in a fluid. For example, the target particle may be a biological material such as a stem cell, a cancer cell, a zygote, a protein, a T-cell, a bacteria, a component of blood, a DNA fragment, for example, suspended in a buffer fluid such as saline. The inlet channel 120 may be formed in the same fabrication plane as the microfabricated valve or movable member 110 and the filter 1, 2 or 3. Accordingly, the flow through these structures may be substantially parallel to a plane of the fabrication substrate, and the flow of the fluid is substantially in that plane. The motion of the microfabricated valve or movable member 110 may also be within this fabrication plane. The decision to sort/save or dispose/waste a given particle may be based on any number of distinguishing signals. In one exemplary embodiment, the decision is based on a fluorescence signal emitted by the particle, based on a fluorescent tag affixed to the particle and excited by an illuminating laser. Details as to this detection mechanism are well known in the literature, and further discussed below with respect to FIG. 4a2. However, other sorts of distinguishing signals may be anticipated, including scattered light or side scattered light which may be based on the morphology of a particle, or any number of mechanical, chemical, electric or magnetic effects that can identify a particle as being either a target particle, and thus sorted or saved, or an nontarget particle and thus rejected or otherwise disposed of.

With the microfabricated valve 110 in the position shown, the input stream passes unimpeded to an output orifice and channel 140 which is out of the plane of the inlet channel 120, and thus out of the fabrication plane of the device 100. That is, the flow is from the inlet channel 120 to the output orifice 140, from which it flows substantially vertically, and thus orthogonally to the inlet channel 120. This output orifice 140 leads to an out-of-plane channel that may be perpendicular to the plane of the paper as shown in FIG. 4a. More generally, the output channel 140 is not parallel to the plane of the inlet channel 120 or sort channel 122, or the fabrication plane of the movable member 110.

The output orifice 140 may be a hole formed in the fabrication substrate, or in a covering substrate that is bonded to the fabrication substrate. Further, the microfabricated valve 110 may have a curved diverting surface 112 which can redirect the flow of the input stream into a sort output stream. The contour of the orifice 140 may be such that it overlaps some, but not all, of the inlet channel 120 and sort channel 122. By having the contour 140 overlap the inlet channel, and with relieved areas described above, a route exists for the input stream to flow directly into the waste orifice 140 when the movable member or microfabricated valve 110 is in the un-actuated waste position.

FIG. 4b is a plan view of the microfabricated device 100 in the actuated position. In this position, the movable member or microfabricated valve 110 is deflected upward into the position shown in FIG. 4b. The diverting surface 112 is a sorting contour which redirects the flow of the inlet channel 120 into the sort output channel 122. The output channel 122 may lie in substantially the same plane as the inlet channel 120, such that the flow within the sort channel 122 is also in substantially the same plane as the flow within the inlet channel 120. There may be an angle between the inlet channel 120 and the sort channel 122, This angle may be any value up to about 90 degrees. Actuation of movable member 110 may arise from a force from force-generating apparatus 400, shown generically in FIG. 4b. In some embodiments, force-generating apparatus may be an electromagnet, however, it should be understood that force-generating apparatus may also be electrostatic, piezoelectric, or some other means to exert a force on movable member 110, causing it to move from a first position (FIG. 4a) to a second position (FIG. 4b).

As can be seen in FIGS. 4a and 4b, the tolerances and gaps in the microfabricated device 100 may be exceedingly small, such that even small particles of debris flowing in the sample stream may cause performance issues with microfabricated device 100.

To achieve these tolerances, the micromechanical particle manipulation device shown in FIGS. 4a and 4b may be formed on a surface of a fabrication substrate, wherein the micromechanical particle manipulation device may include a microfabricated, movable member 110 having a first diverting surface 112, wherein the movable member 110 moves from a first position to a second position in response to a force applied to the movable member, wherein the motion is substantially in a plane parallel to the surface, a sample inlet channel 120 formed in the substrate and through which a fluid flows, the fluid including one or more target particles and non-target material, wherein the flow in the sample inlet channel is substantially parallel to the surface, and a plurality of output channels 122, 140 into which the microfabricated member diverts the fluid, and wherein the flow in at least one of the output channels 140 is not parallel to the plane, and wherein at least one output channel 140 is located directly below at least a portion of the movable member 110 over at least a portion of its motion.

In one embodiment, the diverting surface 112 may be nearly tangent to the input flow direction as well as the sort output flow direction, and the slope may vary smoothly between these tangent lines. In this embodiment, the moving mass of the stream has a momentum which is smoothly shifted from the input direction to the output direction, and thus if the target particles are biological cells, a minimum of force is delivered to the particles. The micromechanical particle manipulation device 100 has a first diverting surface 112 with a smoothly curved shape, wherein the surface which is substantially tangent to the direction of flow in the sample inlet channel at one point on the shape and substantially tangent to the direction of flow of a first output channel at a second point on the shape, wherein the first diverting surface diverts flow from the sample inlet channel into the first output channel when the movable member 110 is in the first position, and allows the flow into a second output channel in the second position.

It should be understood that although channel 122 is referred to as the “sort channel” and orifice 140 is referred to as the “waste orifice”, these terms can be interchanged such that the sort stream is directed into the waste orifice 140 and the waste stream is directed into channel 122, without any loss of generality. Similarly, the “inlet channel” 120 and “sort channel” 122 may be reversed. The terms used to designate the three channels are arbitrary, but the inlet stream may be diverted by the microfabricated valve 110 into either of two separate directions, at least one of which does not lie in the same plane as the other two. The term “substantially” when used in reference to an angular direction, i.e. substantially tangent or substantially vertical, should be understood to mean within 15 degrees of the referenced direction. For example, “substantially orthogonal” to a line should be understood to mean from about 75 degrees to about 105 degrees from the line.

The vertical waste channels 140 may be made by forming a hole in an additional substrate, and gluing the additional substrate to the SOI wafer. Additional details as to the fabrication of these devices may be found in U.S. Pat. No. 9,372,144 issued Jun. 21, 2016.

Typical dimensions of the microfabricated channels are on the order of 50 microns wide and 50 microns deep. The filter barriers may on the order of 30 microns in length and length 10 microns in width. Accordingly, filter barriers 22 and 24 may span just over half of the width of the channel, such that they are staggered as shown in FIG. 1b to allow the sample stream to pass through.

As mentioned above, the microfabricated filter may be used in series with a particle manipulation system, for example, a MEMS-based cell sorting device. The microfabricated filter substrate 10 and transparent layer 30 may be stacked above another substrate which contains the microfabricated movable member 110. Alternatively, the filter barriers may be formed on the same substrate as the movable valve 110, and thus located adjacent to the movable member 110. In either case, the input channel of the filter substrate 10 may be plumbed to a sample reservoir containing a quantity of the sample fluid, and the output channel 20 may be plumbed to the sample inlet channel 120, to provide a filtered fluid sample free of particulate debris which might otherwise become clogged in the movable member 110.

The microfabricated filter may be manufactured using well known photolithographic techniques. The stationary filter barriers 22-38 may be made by deep reactive ion etching (DRIE) in the same manner as the movable member 110. DRIE tends to form quite vertical sidewalls on the features, and precise dimensional tolerances may be maintained. Further details as to the fabrication of microfabricated filter structure 1, 2 and 3 and microfabricated particle manipultioan device 100 may be found in U.S. Pat. No. 9,372,144, issued 21 Jan. 2016 and incorporated by reference in its entirety.

A filter for capturing and analyzing debris in a microfluidic system has been described. The filter may include an inlet port wherein a sample fluid having particulates suspended therein is introduced to the filter and an output port whereby the sample fluid exits the filter, wherein the inlet port and the output port are formed in a silicon substrate and the sample fluid flows in a plane substantially parallel to the surface from the inlet to the outlet port. It may also include at least one microchannel in a surface of the silicon substrate, and through which the sample fluid flows, and a plurality of barriers formed in at least one, wherein a distance between the closest barriers is small enough to capture the particulate debris but allow the sample fluid to flow. The filter may also include a transparent layer that covers the silicon substrate, and the plurality of barriers.

Within the filter so described, the plurality of barriers may have a tapered shape, narrowing from base to tip. The tapered barriers may be inclined into the sample fluid, such that the tapered shape points upstream into the flow. Alternatively, the plurality of barriers may have a tapered shape which is inclined away from the sample fluid, such that the tapered shape points downstream in the flow. In another embodiment, the plurality of barriers may have a tapered shape, wherein the tapered shape has a sharp, tooth-like tip. The plurality of barriers may have a separation between each barrier, and that separation may be narrower than a characteristic dimension of the particulate debris.

In some embodiments, the separation between the barriers becomes narrower as the flow proceed downstream in a microfluidic channel. In some embodiments, the silicon substrate may have a plurality of sample fluid channels formed therein, wherein each channel has a plurality of barriers formed therein, and the barriers in each channel are configured to intercept a different type of particulate debris. In another embodiment, a shape and a size of the barriers in a microchannel may change as a function of distance down the microchannel, such that the barriers at any point are configured to intercept a particular sort or size of particulate. The particulates may be at least one of debris, contamination or biological material.

The filter may also have a transparent layer. The transparent layer may comprise at least one of quartz, sapphire, zirconium, ceramic, and glass. The transparent layer may form a ceiling for the microfabricated channels, confining the sample fluid to the channels. An optical microscope may be is disposed adjacent to the substrate and may be configured to image the particulates intercepted by the plurality of barriers, through the transparent layer. The analysis tool may alternatively be a spectrometer which is disposed adjacent to the filter and is configured to analyze the particulates intercepted by the plurality of barriers, through the transparent layer.

The filter may be disposed upstream of a microfabricated MEMS cell sorting device. The MEMS cell sorting device may have a movable microfluidic valve that moves in a plane parallel to the substrate on which the MEMS cell sorting device is fabricated.

Also, a method for analyzing contaminants is disclosed. The method may include flowing a sample fluid through the filter described above, and analyzing the particulates intercepted by the plurality of barriers in the silicon substrate using at least one of a microscope and a spectrometer, through the transparent layer.

Another method is disclosed for making a filter for capturing and analyzing debris in a microfluidic system. This method may include forming an inlet port wherein a sample fluid having particulates suspended therein is introduced to the filter, forming an output port whereby the sample fluid exits the filter, wherein the inlet port and the output port are formed in a silicon substrate and the sample fluid flows in a plane substantially parallel to the surface from the inlet to the outlet port. The method may further include forming a plurality of microchannels in the surface of the silicon substrate, wherein the sample fluid flows in the microchannels, forming a plurality of barriers in the microchannels formed in the silicon substrate, wherein a distance between the closest barriers is small enough to capture the particulate debris but allow the sample fluid to flow. The method may also include disposing a transparent layer over the silicon substrate, and the plurality of barriers, thereby enclosing the sample fluid within the microchannels. In this method, the plurality of microchannels and the plurality of barriers may be formed in a surface of the silicon substrate by deep reactive ion etching.

While various details have been described in conjunction with the exemplary implementations outlined above, various alternatives, modifications, variations, improvements, and/or substantial equivalents, whether known or that are or may be presently unforeseen, may become apparent upon reviewing the foregoing disclosure. Accordingly, the exemplary implementations set forth above, are intended to be illustrative, not limiting.

What is claimed is:

1. A filter for capturing and analyzing debris in a microfluidic system, comprising:
an inlet port wherein a sample fluid having particulates suspended therein is introduced to the filter and an output port whereby the sample fluid exits the filter, wherein the inlet port and the output port are formed in a silicon substrate and the sample fluid flows in a plane substantially parallel to the surface from the inlet to the outlet port;
at least one microchannel in a surface of the silicon substrate, and through which the sample fluid flows;
a plurality of barriers formed in at least one, wherein a distance between the closest barriers is small enough to capture the particulate debris but allow the sample fluid to flow; and
a transparent layer that covers the silicon substrate, and the plurality of barriers.

2. The filter of claim 1, wherein at least one of the plurality of barriers has a tapered shape, narrowing from base to tip

3. The filter of claim 1, wherein at least one of the plurality of barriers has a tapered shape, and is inclined into the sample fluid, such that the tapered shape points upstream into the flow.

4. The filter of claim 1, wherein at least one of the plurality of barriers has a tapered shape, and is inclined away from the sample fluid, such that the tapered shape points downstream in the flow.

5. The filter of claim 1, wherein at least one of the plurality of barriers has a tapered shape, wherein the tapered shape has a sharp, tooth-like tip.

6. The filter of claim 1, wherein the filter is disposed upstream of a microfabricated MEMS cell sorting device.

7. The filter of claim 1, wherein the MEMS cell sorting device has a movable microfluidic valve that moves in a plane parallel to the substrate.

8. The filter of claim 1, wherein at least one of the plurality of barriers has a rectangular shape, and there is a varying distance between opposing barriers.

9. The filter of claim 1, wherein the plurality of barriers has a separation between each barrier, and that separation is narrower than a characteristic dimension of the particulate debris.

10. The filter of claim 1, wherein the separation between the barriers becomes narrower as the flow proceed downstream in a microfluidic channel.

11. The filter of claim 1, wherein the silicon substrate has a plurality of sample fluid channels formed therein, wherein each channel has a plurality of barriers formed therein, and the barriers in each channel are configured to intercept a different type of particulate debris.

12. The filter of claim 1, wherein the transparent layer comprises at least one of quartz, sapphire, zirconium, ceramic, and glass.

13. The filter of claim 1, wherein a shape and a size of the barriers in a microchannel changes as a function of distance down the microchannel, such that the barriers at any point are configured to intercept a particular sort or size of particulate.

14. The filter of claim 1, wherein the particulates are at least one of debris, contamination or biological material.

15. The filter of claim 1, further comprising an optical microscope which is disposed adjacent to the filter and is configured to image the particulates intercepted by the plurality of barriers, through the transparent layer.

16. The filter of claim 1, further comprising a spectrometer which is disposed adjacent to the filter and is configured to analyze the particulates intercepted by the plurality of barriers, through the transparent layer.

17. The filter of claim 1, wherein the transparent layer forms a ceiling for the microfabricated channels, confining the sample fluid to the channels.

18. A method of analyzing contaminants in a sample fluid, comprising:
flowing a sample fluid through the filter of claim 1; and
analyzing the particulates intercepted by the plurality of barriers in the silicon substrate using at least one of a microscope and a spectrometer, through the transparent layer.

19. A method for making a filter for capturing and analyzing debris in a microfluidic system, comprising:
forming an inlet port wherein a sample fluid having particulates suspended therein is introduced to the filter forming an output port whereby the sample fluid exits the filter, wherein the inlet port and the output port are formed in a silicon substrate and the sample fluid flows in a plane substantially parallel to the surface from the inlet to the outlet port;
forming a plurality of microchannels in the surface of the silicon substrate, wherein the sample fluid flows in the microchannels;
forming a plurality of barriers in the microchannels formed in the silicon substrate, wherein a distance between the closest barriers is small enough to capture the particulate debris but allow the sample fluid to flow; and
disposing a transparent layer over the silicon substrate, and the plurality of barriers, thereby enclosing the sample fluid within the microchannels.

20. The method of claim 19, wherein the plurality of microchannels and the plurality of barriers is formed in a surface of the silicon substrate by deep reactive ion etching.
